(19) United States
(12) Patent Application Publication
(10) Pub. No.: US 2016/0196556 A1
(43) Pub. Date: Jul. 7, 2016

(54) FUND TRANSFER

(71) Applicant: Verizon Patent and Licensing Inc., Arlington, VA (US)

(72) Inventors: Niloufer TAMBOLY, Edison, NJ (US); Kasinath IYER, Basking Ridge, NJ (US); Julie ABBOTT, Towaco, NJ (US); Aneeta ARESTANI, Edison, NJ (US); Praveen ATREYA, Jersey City, NJ (US); Carl E. PALITTI, Jr., Jersey City, NJ (US)

(73) Assignee: VERIZON PATENT AND LICENSING INC.

(21) Appl. No.: 14/591,830

(22) Filed: Jan. 7, 2015

(51) Int. Cl. G06Q 20/40; G06Q 20/32; H04W 4/02; G06Q 20/38; H04W 4/00; H04W 4/12

(52) U.S. Cl. CPC G06Q 20/40; H04W 4/008; H04W 4/12; H04W 4/02; G06Q 20/3829; G06Q 20/3224; G06Q 20/3278

(57) ABSTRACT

Systems and methods for an enhanced fund transfer service are described. Some implementations include receiving, at a first mobile station, instructions to preauthorize a particular value of funds for a transaction, generating, at the first mobile station and based on the instructions, a preauthorization for the particular value of funds, where the preauthorization identifies one or more of: the particular value, a particular time when the preauthorization expires or a geographic location within which the preauthorization is valid, transmitting the generated preauthorization, from the first mobile station to a second mobile station, where the preauthorization is used by the second mobile station complete a transaction within the particular value, and displaying an indication at the first mobile station when the transaction using the preauthorization is completed using the second mobile station, where the indication includes a transacted value of funds and an identification of an entity that received the transacted funds.

### BACKGROUND

In recent years, mobile station (e.g., smartphone) usage has significantly increased. Use of wireless mobile stations for online transactions—e.g., for purchasing goods, receiving downloads, and so on—which involve the Internet are well known. Further, mobile stations, such as cell phones or other personal digital assistants, are also being used for making transactions. Mobile stations that include a near field communication (NFC) device allow a user to securely make a simple transaction, such as, purchasing an item (e.g., book) at a store. In such an example, the user typically waves the mobile station near a reader installed in the store, and a price of the item is deducted from the user's credit or banking account via the user's mobile station. Often, a user can encounter scenarios where they may be with other people (e.g., children) who need to perform transactions using credit card information (or similar methods) owned by the user. In such scenarios, the user would need to provide to a requestor the user's credit card or mobile station equipped with an NFC payment device. However, this can be inconvenient for the user and may cause concerns with the mobile station being lost, unauthorized transactions or confidential financial information being made public.

As the foregoing illustrates, a new approach for fund transfers with consideration to such concerns may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high-level functional block diagram of an exemplary system of networks/devices that provide various communications for mobile stations and support an example of the enhanced fund transfer service.

FIGS. 2A-2F are exemplary user interfaces that may be displayed at the mobile stations in accordance with the disclosed implementations.

FIG. 3A is a flowchart illustrating an exemplary generation of a preauthorization in accordance with the disclosed implementations.

FIG. 3B is another flowchart illustrating an exemplary generation of a preauthorization in accordance with the disclosed implementations.

FIG. 3C is a flowchart illustrating exemplary decryption and use of a preauthorization in accordance with the disclosed implementations.

FIG. 4 is a high-level functional block diagram of an exemplary non-touch type mobile station that may utilize the enhanced fund transfer service through a network/system like that shown in FIG. 1.

FIG. 5 is a high-level functional block diagram of an exemplary touch screen type mobile station that may utilize the enhanced fund transfer service through a network/system like that shown in FIG. 1.

FIG. 6 is a simplified functional block diagram of a computer that may be configured as a host or server, for example, to assist in fund transfer operations occurring in the system of FIG. 1.

FIG. 7 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various implementations disclosed herein relate to an enhanced fund transfer service. As shall be described further below, the disclosed implementations allow a user to preauthorize a particular value of funds for transactions to be performed at mobile stations other than the user's mobile station. In this way, when a user may encounter scenarios where they may be with other people (e.g., children) who need to perform transactions using a mobile station (equipped with an NFC payment device) that is owned by the user, the user need not provide to a requestor the user's mobile station. Instead, the user can conveniently preauthorize the requestor's mobile station to perform a particular transaction. This may alleviate concerns with the user's mobile station being misplaced or confidential financial information being made public.

Reference now is made in detail to the examples illustrated in the accompanying drawings and discussed below.

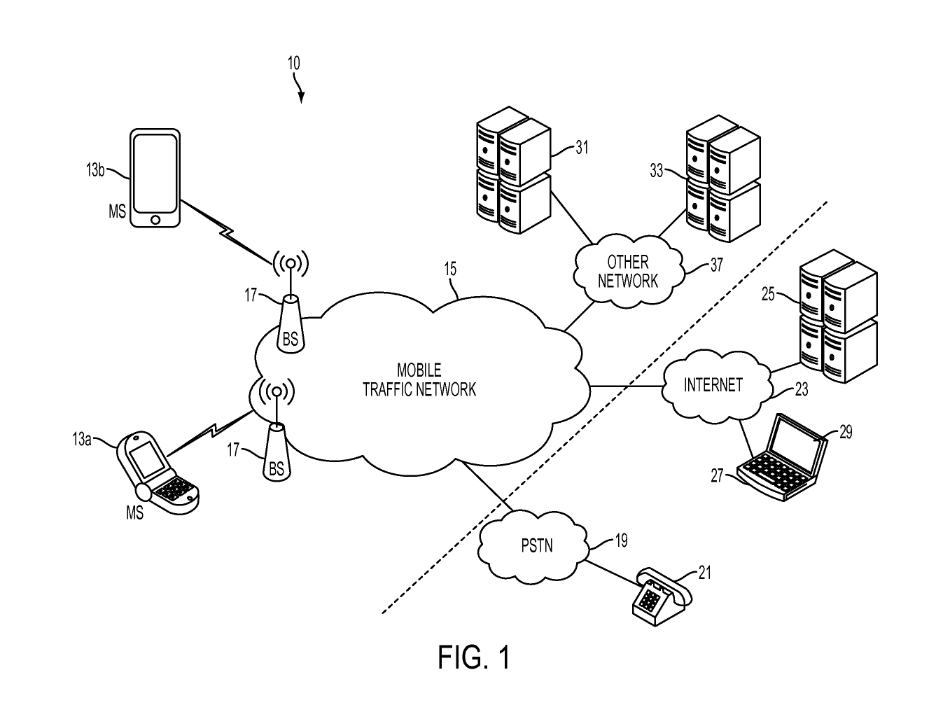

FIG. 1 illustrates an exemplary system 10 offering a variety of mobile communication services, including communications related to the enhanced fund transfer service by mobile station users. The example shows simply two mobile stations (MSs) 13a and 13b as well as a mobile communication network 15. The first mobile station 13a and the second mobile station 13b are examples of mobile stations that may perform the enhanced fund transfer service. However, the network will provide similar communications for many other similar users as well as for mobile devices/users that do not participate in communication with the enhanced fund transfer service. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Long Term Evolution (LTE) standard, the Global System for Mobile (GSM) communication standard, a time division multiple access (TDMA) standard or other standards used for public mobile wireless communications. The mobile stations 13a and 13b may are capable of voice telephone communications through the network 15, and for communication related to the enhanced fund transfer service the exemplary devices 13a and 13b are capable of data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13a and 13b via the Internet 23 may be with devices like those shown at 25 and 27 as well as with a variety of other types of devices or systems capable of data communications through various interconnected networks. The mobile stations 13a and 13b can also can receive and execute applications written in various programming languages, as discussed more later.

Mobile stations 13a and 13b can take the form of portable handsets, smart-phones or personal digital assistants, although they may be implemented in other form factors. Program applications, including an application to assist in the enhanced fund transfer service and/or an application associated with the enhanced fund transfer service can be configured to execute on many different types of mobile stations 13a and 13b. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as those serving mobile stations 13a and 13b, can include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13a and 13b, when the mobile stations 13a and 13b are within range. Each base station can include a BTS coupled to several antennae mounted on a radio tower within a coverage area often referred to as a “cell.” The BTS is the part of the radio network that sends and receives RF signals to/from the mobile stations 13a and 13b that are served by the base station 17.

The radio access networks can also include a traffic network represented generally by the cloud at 15, which carries the user communications and data for the mobile stations 13a and 13b between the base stations 17 and other elements with or through which the mobile stations 13a and 13b communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier can also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13a or 13b communicates over the air with a base station 17 and through the traffic network 15 for various voice and data communications, e.g. through the Internet 23 with a server 25 and/or with application servers 31. If the mobile service carrier offers an enhanced fund transfer service, the service may be hosted on a carrier operated application server 31, for communication via the networks 15 and 29. Alternatively, the enhanced fund transfer service may be provided by a separate entity (alone or through agreements with the carrier), in which case, the service may be hosted on an application server such as server 25 connected for communication via the networks 15 and 23. Server such as 25 and 31 may provide any of a variety of common application or service functions in support of or in addition to an application program running on the mobile station 13. However, for purposes of further discussion, we will focus on functions thereof in support of the enhanced fund transfer service. For a given service, an application program within the mobile station may be considered as a ‘client’ and the programming at 25 or 31 may be considered as the ‘server’ application for the particular service.

To insure that the application service offered by server 31 is available to only authorized devices/users, the provider of the application service also deploys an authentication server 33. The authentication server 33 could be a separate physical server as shown, or authentication server 33 could be implemented as another program module running on the same hardware platform as the server application 31. Essentially, when the server application (server 31 in our example) receives a service request from a client application on a mobile station 13a or 13b, the server application provides appropriate information to the authentication server 33 to allow server application 33 to authenticate the mobile station 13a or 13b as outlined herein. Upon successful authentication, the server 33 informs the server application 31, which in turn provides access to the service via data communication through the various communication elements (e.g. 29, 15 and 17) of the network 10. A similar authentication function may be provided for enhanced fund transfer service(s) offered via the server 25, either by the server 33 if there is an appropriate arrangement between the carrier and the operator of server 24, by a program on the server 25 or via a separate authentication server (not shown) connected to the Internet 23.

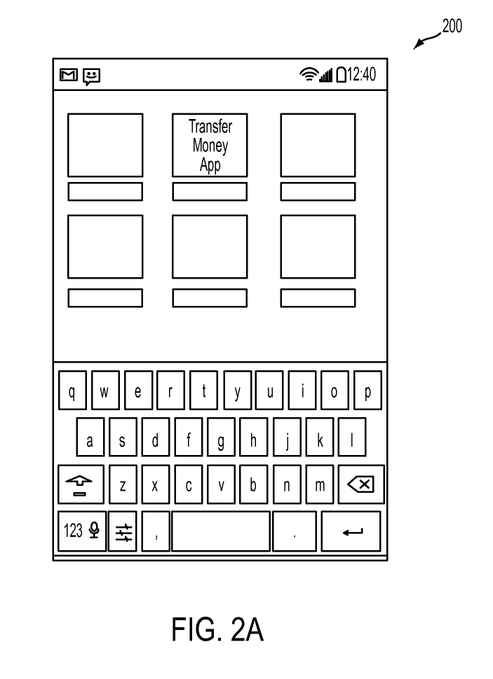

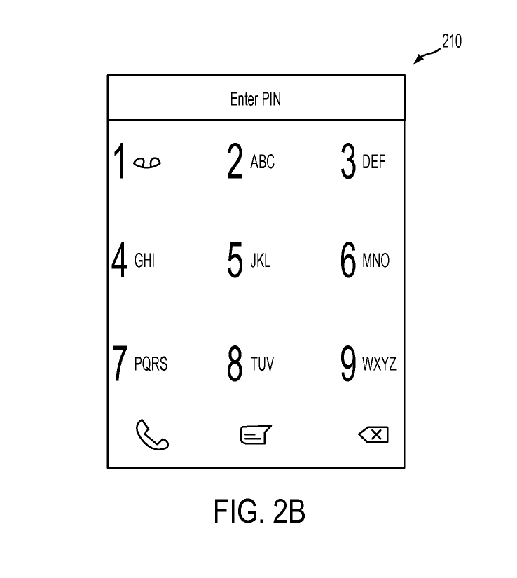

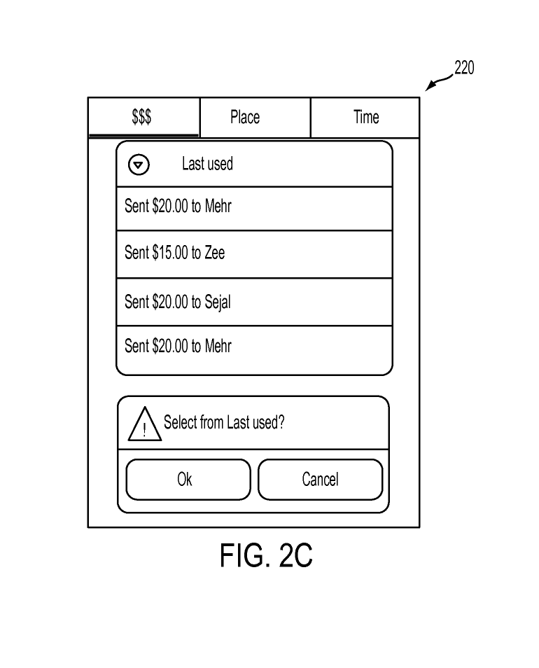

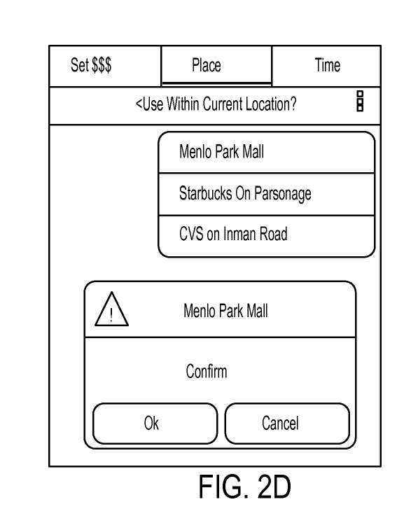

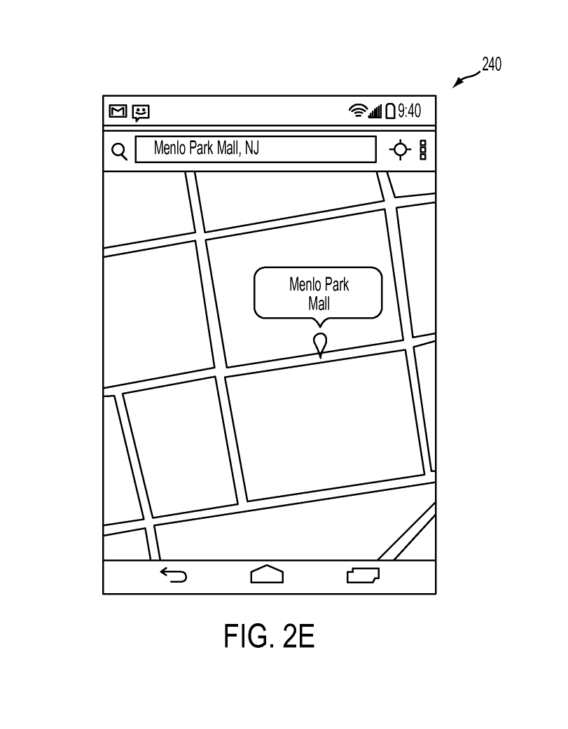

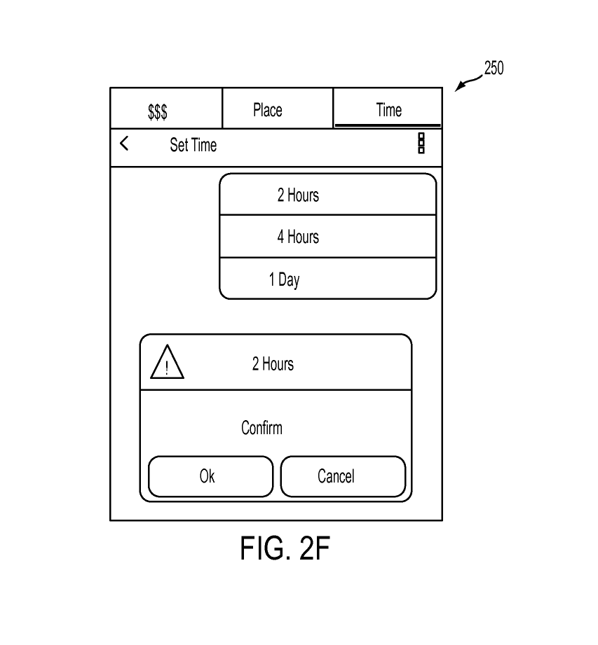

Some implementations include receiving, at a first mobile station (e.g., mobile station 13a), instructions to preauthorize a particular value of funds for a transaction. For example the instructions may be received, via a fund transfer mobile application illustrated in interface 200 in FIG. 2A. The user may select the mobile application and then can be presented with another interface 210 (FIG. 2B) requesting that the user enter a password or a personal identification number (PIN). Any other form of user authentication/verification method may be used, including but not limited to, fingerprint scan, biometric scan or retina scan. In addition, voice recognition techniques may also be used. In some implementations, a user may be able to select different authentication techniques. For example, a selection menu may be presented to a user that allows the user to select between a fingerprint authentication method or a voice authentication method In some implementations, a maximum or pre-authorized amount may be segmented in a particular time period based on an authentication technique (e.g., voice recognition=$20/day, biometric scan=$30/day, PIN=$40/hour, etc.). In some implementations, only amounts based on selected authentication techniques may be displayed to the user. In some implementations, a number of transactions displayed in a list may be dependent on a type of authentication (e.g., voice=see only last 3, PIN=see last 5), or based on time. If the PIN entered by the user is valid, the user may be presented with user interface 220 (FIG. 2C) that provides the user with a list of most recent previously made transactions and may also provide an option to the user to repeat any one of the previously made transactions. The previously made transactions may be limited to threshold amounts or require additional (different) authentication if over the threshold. Any additional authentication may be indicated on the user interface. In some implementations, the threshold may be dependent on a type of original authentication. The user may also be able to provide instructions to preauthorize a particular value of funds for a transaction that may not be included within the displayed list of previous transactions. For example, the user may enter an amount (e.g. $10), and subsequently enter a phone number (or select a contact from a contacts list). Then, as shown in interface 230 (FIG. 2D), the user may enter the name of a mall, store or any other location or select any vendor(s) (e.g., Menlo Park Mall) from a map interface 240. The locations displayed on the may be limited based on an preauthorization value, authentication type, current location, person to whom the transfer is being provided, etc.). In some implementations, a user may define a geographical limit to be generated via the map (e.g., draw a circle) and may cause display all of the stores within the limit drawn (i.e., display on the map that an Apple store, GAP, etc. is within the circle.) The user may also confirm the geographic location by selecting an appropriate user interface element (e.g., “OK” button). The user can also be provided with an option that lets the user select the user's current location (e.g., mall or store) within which the preauthorization is to remain valid.

Once the user has selected a place or geographic location using the interfaces illustrated in FIGS. 2D or 2E, the user may be presented with an interface 250 (FIG. 2F) that allows the user to select a time period (e.g., 2 hours, 4 hours, 1 day) measured from a current time value for which the preauthorization is to remain valid. In some implementations, the user may also directly input a date or time (e.g., June 12, 10:00AM EST) beyond which the preauthorization is to expire or become invalid. In some implementations, a notification and override mechanism within a preset period before the expiration time if the monetary amount has not been used may be provided (e.g., provided on the user device that established the transaction or on a predetermined device). As illustrated in interface 250, the user may also confirm the time value by selecting an appropriate user interface element (e.g., “OK” button).

In some implementations, when the user has performed the actions illustrated in FIGS. 2A-2F, the mobile station 13a can generate, based on the instructions, a preauthorization for the particular value of funds, wherein the preauthorization identifies one or more of: the particular value, a particular time when the preauthorization expires or a geographic location within which the preauthorization is valid. For example, the preauthorization may be for $10 for 2 hours at the Menlo Park Mall. The preauthorization may be transmitted from the mobile station 13a to the second mobile station (e.g., the mobile station 13b). The preauthorization can be used by the second mobile station 13b complete a transaction within the particular value (e.g., less than or equal to $10).

In some implementations, the generated preauthorization may be transmitted from the first mobile station 13a to the second mobile station 13b using NFC (e.g., secure SIM or Host-based Card Emulation) or data over sound (e.g., Differential Phase Shifting Key using the 18.4 kHz-20.8 kHz frequency range). NFC is a set of standards for smartphones and other mobile devices to establish radio communication with each other by touching them together or bringing them into close proximity, usually no more than a few centimeters. Current NFC systems use a radio frequency of 13.56 MHz, corresponding to a wavelength of 22.11 m. The NFC system used by the disclosed implementations may operate in a peer-to-peer (or P2P) mode. Peer-to-peer mode allows two NFC-enabled devices to communicate with each other to exchange information and share files, so that users of NFC-enabled devices can quickly share contact information and other files with a touch or when in proximity. For example, users can share Bluetooth or WiFi link set-up parameters or exchange data such as virtual business cards or digital photos. Peer-to-peer mode is standardized on the ISO/IEC 18092 standard and based on NFC Forum's Logical Link Control Protocol Specification.

In some implementations, an indication at the first mobile station 13a is displayed when the transaction using the preauthorization is completed using the second mobile station 13b. The indication can be a notification or a pop-up that displays a transacted value of funds (e.g., $ 8.50, $10 etc.) and an identification of an entity (e.g., ABC Ice Cream Shop) that received the transacted funds. In this way, the disclosed implementations allow a user to preauthorize a particular value of funds for transactions to be performed at mobile stations other than the user's mobile station. A user may encounter scenarios where they may be with other people (e.g., children) who need to perform transactions using a mobile station owned by the user. In these scenarios the user need not to provide to a requestor the user's mobile station. This is convenient for the user and may alleviate concerns with the user's mobile station being misplaced or confidential financial information being made public.

In some implementations, the generated preauthorization is transmitted using NFC when the first mobile station 13a and the second mobile station 13b are in proximity. The generated preauthorization may be encrypted at the first mobile station 13a prior to transmission to the second mobile station 13b. The mobile station 13a may transmit a decryption key to the second mobile station 13b. The decryption key may be used by the second mobile station 13b to decrypt the encrypted preauthorization. The decryption key is transmitted from the first mobile station 13a to the second mobile station 13b over a channel separate from what is used for transmission of the generated preauthorization. For example, if the encrypted preauthorization is transmitted over NFC, the decryption key may be transmitted over email or short messaging service (SMS). In some implementations, the preauthorization can be automatically canceled (e.g., erased from memory) at the second mobile station 13b when the particular time value (e.g., hours, minutes and seconds) is equal or greater than a current time value or the second mobile station 13b is outside the geographic location for which the preauthorization is granted. For example, if the preauthorization is granted for a “Mall A,” the preauthorization may be automatically canceled when the mobile station 13b is outside Mall A or a predetermined distance from Mall A.

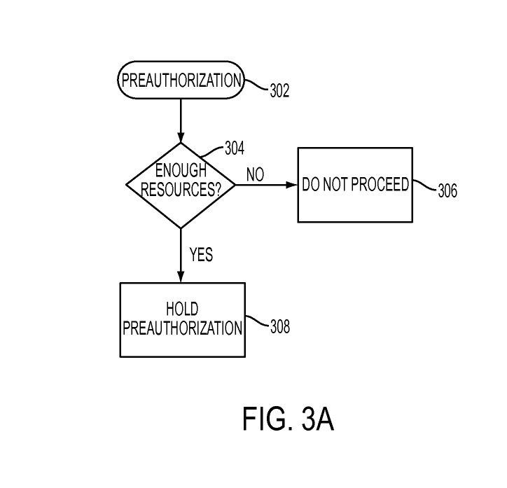

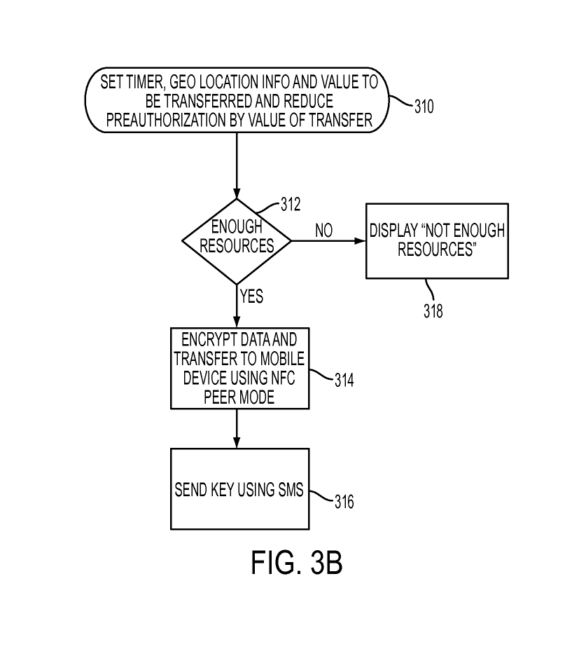

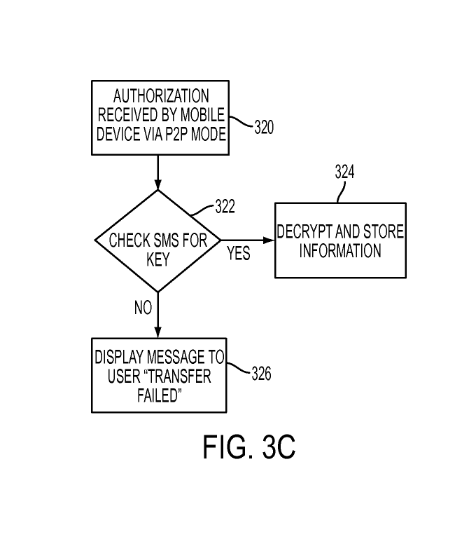

FIG. 3A illustrates an exemplary flow of operations that may be performed at the first mobile station 13a. Method 300 begins with receiving instructions to generate a preauthorization at the first mobile station 13a (step 302). The mobile station 13a (or an electronic payment application) may check whether there are sufficient funds available in a user's electronic credit or banking account to generate the preauthorization (step 304). The user's electronic or banking account may be determined based on a past transaction history of a user and particularly whether the user has used a particular transaction method more frequently than another one. If there are sufficient funds available (step 304), the preauthorization can be generated at the first mobile station 13a (step 306). Otherwise, the preauthorization is not generated or is held till sufficient funds are available (step 308).

FIG. 3B illustrates another exemplary flow of operations that may be performed at the first mobile station 13b. In step 310, instructions to generate a preauthorization may be received at the first mobile station 13a. The preauthorization instructions can identify one or more of: a particular value of funds, a particular time when the preauthorization expires or a geographic location within which the preauthorization is valid. The mobile station 13a (or an electronic payment application) may check whether there are sufficient funds available in a user's electronic credit or banking account to generate the preauthorization (step 312). If there are sufficient funds available (step 312), a generated preauthorization may be encrypted at the first mobile station 13a prior to transmission to the second mobile station 13b (step 314). The mobile station 13a may transmit a decryption key to the second mobile station 13b (step 316). The decryption key may be used by the second mobile station 13b to decrypt the encrypted preauthorization. The decryption key is transmitted from the first mobile station 13a to the second mobile station 13b over a channel separate from what is used for transmission of generated preauthorization. For example, if the encrypted preauthorization is transmitted over NFC, the decryption key may be transmitted over email or short messaging service (SMS). Returning to step 312, if sufficient funds are not available (step 312), a message indicating that sufficient funds are not available to generate the preauthorization is displayed at the first mobile station 13a (step 318). In some implementations, an amount less than the preauthorized funds may be provided if sufficient funds are not available.

FIG. 3C is a flowchart indicating an exemplary overall operation at the second mobile station 13b in accordance with some implementations. In step 320, the second mobile station 13b may receive an encrypted preauthorization from the first mobile station 13a. The second mobile station 13b may then check its SMS inbox to determine whether a decryption key has been received from the first mobile station 13b (step 322). If a decryption key has been received from the first mobile station 13a (step 322), then the second mobile station 13b decrypts the encrypted preauthorization received in step 320 with the decryption key and then uses the information included in the preauthorization for transactions (step 324). For example, information included in the preauthorization may include at least one of a particular value of funds, a particular time when the preauthorization expires or a geographic location within which the preauthorization is valid. For example, the preauthorization may be for $10 for 2 hours at the Menlo Park Mall. If a decryption key has not been received from the first mobile station 13a (step 322), then the second mobile station 13b displays a failure message (step 326).

In some implementations, a two-stage process may be implemented where an initial preauthorization setup occurs when the two devices are near (and a notification is sent to the network) but the key is not passed to the receiving device until the network determines that it is at or near the location at the time. In some implementations, the aspects discussed above may be implemented within a digital wallet application that resides on both mobile station 13a and mobile station 13b. A digital wallet has both a software and information component. The software provides security and encryption for the personal information and for the actual transaction. Typically, digital wallets are stored on the client side and are easily self-maintained and fully compatible with most e-commerce Web sites. The enhanced fund transfer service under consideration here may be delivered to touch screen type mobile stations as well as to non-touch type mobile stations. Hence, our simple example shows the mobile station (MS) 13a as a non-touch type mobile station and shows the mobile station (MS) 13 as a touch screen type mobile station. Implementation of the on-line enhanced fund transfer service will involve at least some execution of programming in the mobile stations as well as implementation of user input/output functions and data communications through the network 15, from the mobile stations.

Those skilled in the art presumably are familiar with the structure, programming and operations of the various type of mobile stations. However, for completeness, it may be useful to consider the functional elements/aspects of two exemplary mobile stations 13a and 13b, at AS a high-level.

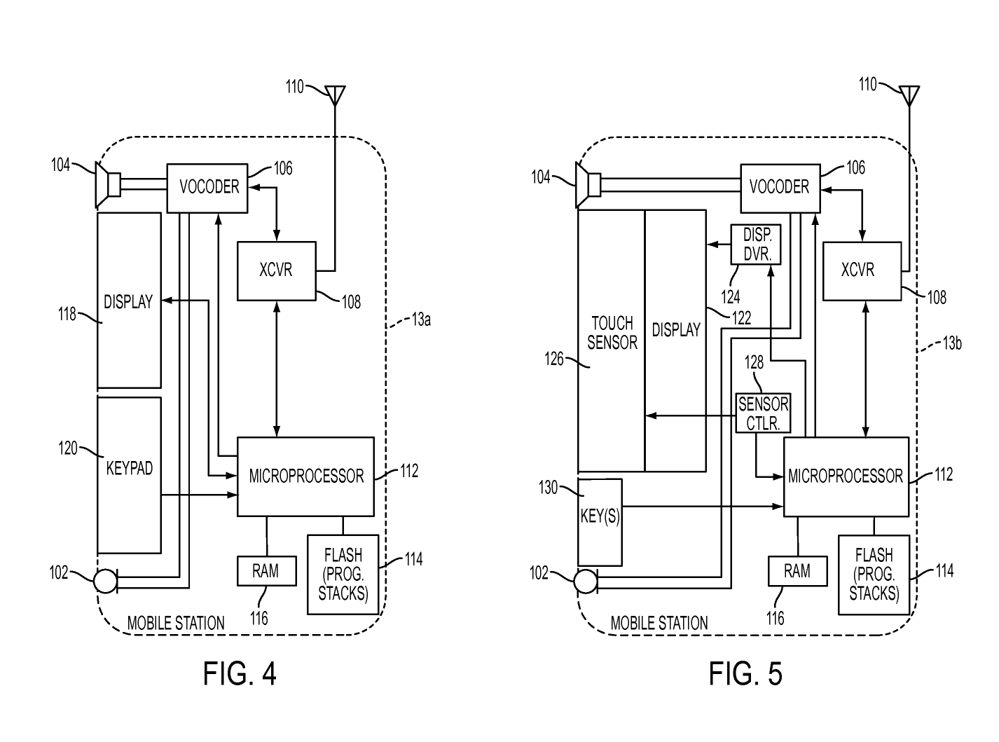

For purposes of such a discussion, FIG. 4 provides a block diagram illustration of an exemplary non-touch type mobile station 13a. Although the mobile station 13a may be a smart-phone or may be incorporated into another device, such as a personal digital assistant (PDA) or the like, for discussion purposes, the illustration shows the mobile station 13a is in the form of a handset. The handset embodiment of the mobile station 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass embodiments of the mobile station 13a utilizing any digital transceivers that conform to current or future developed digital wireless communication standards. The mobile station 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile station 13a includes a display 118 for displaying messages, menus or the like, call related information dialed by the user, calling party numbers, etc., including notifications and user interfaces related to the enhanced fund transfer service. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during the enhanced fund transfer service.

A microprocessor 112 serves as a programmable controller for the mobile station 13a, in that it controls all operations of the mobile station 13a in accord with programming that it executes, for all normal operations, and for operations involved in the enhanced fund transfer service procedure under consideration here. In the example, the mobile station 13a includes flash type program memory 114, for storage of various “software” or “firmware” program routines and mobile configuration settings, such as mobile directory number (MDN) and/or mobile identification number (MIN), etc. The mobile station 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile station 13a includes a processor, and programming stored in the flash memory 114 configures the processor so that the mobile station is capable of performing various desired functions, including in this case the functions involved in techniques for the enhanced fund transfer service

For purposes of such a discussion, FIG. 5 provides a block diagram illustration of an exemplary touch screen type mobile station 13b. Although possible configured somewhat differently, at least logically, a number of the elements of the exemplary touch screen type mobile station 13b are similar to the elements of mobile station 13a, and are identified by like reference numbers in FIG. 5. For example, the touch screen type mobile station 13b includes a microphone 102, speaker 104 and vocoder 106, for audio input and output functions, much like in the earlier example. The mobile station 13b also includes a at least one digital transceiver (XCVR) 108, for digital wireless communications, although the handset 13b may include an additional digital or analog transceiver. The concepts discussed here encompass embodiments of the mobile station 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile station 13b, in that it controls all operations of the mobile station 13b in accord with programming that it executes, for all normal operations, and for operations involved in the enhanced fund transfer procedure under consideration here. In the example, the mobile station 13b includes flash type program memory 114, for storage of various program routines and mobile configuration settings. The mobile station 13b may also include a non-volatile random access memory (RAM) 116 for a working data processing memory. Of course, other storage devices or configurations may be added to or substituted for those in the example. Hence, outlined above, the mobile station 13b includes a processor, and programming stored in the flash memory 114 configures the processor so that the mobile station is capable of performing various desired functions, including in this case the functions involved in the technique for providing the enhanced fund transfer procedure.

In the example of FIG. 4, the user interface elements included a display and a keypad. The mobile station 13b may have a limited number of key 130, but the user interface functions of the display and keypad are replaced by a touchscreen display arrangement. At a high level, a touchscreen display is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display.

Hence, the exemplary mobile station 13b includes a display 122, which the microprocessor 112 controls via a display driver 124, to present visible outputs to the device user. The mobile station 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile station 13b. The microphone 102 and speaker 104 may be used as additional user interface elements, for audio input and output, including with respect to some enhanced fund transfer related functions.

The structure and operation of the mobile stations 13a and 13b, as outlined above, were described to by way of example, only.

As shown by the above discussion, functions relating to the an enhanced fund transfer service, via a graphical user interface of a mobile station may be implemented on computers connected for data communication via the components of a packet data network, operating as a server and/or mobile stations 13a and 13b as shown in FIG. 1. Although special purpose devices may be used, such devices also may be implemented using one or more hardware platforms intended to represent a general class of data processing device commonly used to run “server” programming so as to implement the enhanced fund transfer functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the enhanced fund transfer service. The software code is executable by the general-purpose computer that functions as the server and/or that functions as a mobile terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for the enhanced fund transfer service in essentially the manner performed in the implementations discussed and illustrated herein.

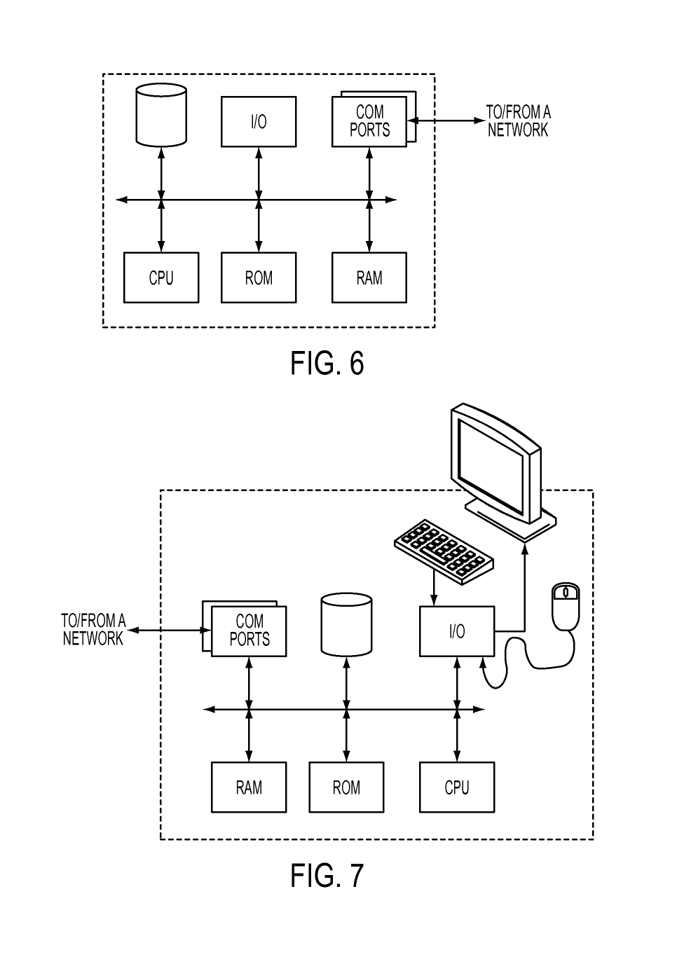

FIGS. 6 and 7 provide functional block diagram illustrations of general purpose computer hardware platforms. FIG. 6 illustrates a network or host computer platform, as may typically be used to implement a server. FIG. 7 depicts a computer with user interface elements, as may be used to implement a personal computer or other type of work station or terminal device, although the computer of FIG. 7 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 6). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of the enhanced fund transfer service outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the wireless network provider into the computer platform of the enhanced fund transfer service. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the enhanced fund transfer service, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
receiving, at a first mobile station, instructions to preauthorize a particular value of funds for a transaction;
generating, at the first mobile station and based on the instructions, a preauthorization for the particular value of funds, wherein the preauthorization identifies one or more of: the particular value, a particular time when the preauthorization expires or a geographic location within which the preauthorization is valid;
transmitting the generated preauthorization, from the first mobile station to a second mobile station, wherein the preauthorization is used by the second mobile station complete a transaction within the particular value; and
displaying an indication at the first mobile station when the transaction using the preauthorization is completed using the second mobile station, wherein the indication includes a transacted value of funds and an identification of an entity that received the transacted funds.

2. The method of claim 1, wherein the generated preauthorization is transmitted using near field communication (NFC) when the first mobile station and the second mobile station are in proximity.

3. The method of claim 1, further comprising:
encrypting the generated preauthorization at the first mobile station prior to transmission to the second mobile station.

4. The method of claim 3, further comprising:
transmitting a decryption key from the first mobile station to the second mobile station, wherein the decryption key is used decrypt the preauthorization at the second mobile station.

5. The method of claim 4, wherein the decryption key is transmitted from the first mobile station to the second mobile station over a channel separate from a channel used for transmission of the generated preauthorization, wherein the channel used to transmit the decryption key includes one or more of email or short messaging service (SMS).

6. The method of claim 3, wherein the preauthorization is automatically canceled at the second mobile station when a stored particular time value is equal or greater than a current time value or the second mobile station is outside geographic location.

7. The method of claim 1, further comprising:
receiving an indication, via a user interface of the first mobile station, identifying the second mobile station or a user associated with the second mobile station; and
receiving another indication, via the user interface, that defines the geographic location.

8. A first mobile station comprising:
a communication interface configured to enable communication via a mobile network;
a processor coupled with the communication interface;
a storage device accessible to the processor; and
an executable program in the storage device, wherein execution of the program by the processor configures the server to perform functions, including functions to:
receive, at the first mobile station, instructions to preauthorize a particular value of funds for a transaction;
generate, at the first mobile station and based on the instructions, a preauthorization for the particular value of funds, wherein the preauthorization identifies one or more of: the particular value, a particular time when the preauthorization expires or a geographic location within which the preauthorization is valid;
transmit the generated preauthorization, from the first mobile station to a second mobile station, wherein the preauthorization is used by the second mobile station complete a transaction within the particular value; and
display an indication at the first mobile station when the transaction using the preauthorization is completed using the second mobile station, wherein the indication includes a transacted value of funds and an identification of an entity that received the transacted funds.

9. The first mobile station of claim 11, wherein the generated preauthorization is transmitted using near field communication (NFC) when the first mobile station and the second mobile station are in proximity.

10. The first mobile station of claim 11, wherein execution of the program by the processor configures the server to perform functions, including functions to:
encrypt the generated preauthorization at the first mobile station prior to transmission to the second mobile station.

11. The first mobile station of claim 10, wherein execution of the program by the processor configures the server to perform functions, including functions to:
transmitting a decryption key from the first mobile station to the second mobile station, wherein the decryption key is used decrypt the preauthorization at the second mobile station.

12. The first mobile station of claim 11, wherein the decryption key is transmitted from the first mobile station to the second mobile station over a channel separate from a channel used for transmission of generated preauthorization, wherein the channel used to transmit the decryption key includes one or more of email or short messaging service (SMS).

13. The first mobile station of claim 8, wherein the preauthorization is automatically canceled at the second mobile station when the particular time value is equal or greater than a current time value or the second mobile station is outside the geographic location.

14. The first mobile station of claim 8, wherein execution of the program by the processor configures the server to perform functions, including functions to:
receive an indication via a user interface identifying the second mobile station or a user associated with the second mobile station; and
receive another indication via the user interface that defines the geographic location.

15. A non-transitory computer-readable medium comprising instructions which, when executed by one or more computers, cause the one or more computers to:
receive, at a first mobile station, instructions to preauthorize a particular value of funds for a transaction;
generate, at the first mobile station and based on the instructions, a preauthorization for the particular value of funds, wherein the preauthorization identifies one or more of: the particular value, a particular time when the preauthorization expires or a geographic location within which the preauthorization is valid;
transmit the generated preauthorization, from the first mobile station to a second mobile station, wherein the preauthorization is used by the second mobile station complete a transaction within the particular value; and
display an indication at the first mobile station when the transaction using the preauthorization is completed using the second mobile station, wherein the indication includes a transacted value of funds and an identification of an entity that received the transacted funds.

16. The computer-readable medium of claim 15, wherein the generated preauthorization is transmitted using near field communication (NFC) when the first mobile station and the second mobile station are in proximity.

17. The computer-readable medium of claim 15 further comprising instructions which, when executed by the one or more computers, cause the one or more computers to:
encrypt the generated preauthorization at the first mobile station prior to transmission to the second mobile station.

18. The computer-readable medium of claim 17, further comprising instructions which, when executed by the one or more computers, cause the one or more computers to:
transmitting a decryption key from the first mobile station to the second mobile station, wherein the decryption key is used decrypt the preauthorization at the second mobile station.

19. The computer-readable medium of claim 18, wherein the decryption key is transmitted from the first mobile station to the second mobile station over a channel separate from what is used for transmission of generated preauthorization, wherein the channel includes one or more of email or short messaging service (SMS).

20. The computer-readable medium of claim 17, wherein the preauthorization is automatically canceled at the second mobile station when the particular time value is equal or greater than a current time value or the second mobile station is outside the geographic location.
